(19) United States
(12) Patent Application Publication
(10) Pub. No.: US 2018/0017397 A1
(43) Pub. Date: Jan. 18, 2018

(54) Method for identifying and generating on demand travel route modifications to include stops along an existing travel route

(71) Applicant: Lee Li Hou, Eagleville, PA (US)

(72) Inventor: Lee Li Hou, Eagleville, PA (US)

(21) Appl. No.: 15/207,937

(22) Filed: Jul. 12, 2016

(51) Int. Cl. G01C 21/34; G01C 21/36

(52) U.S. Cl. CPC G01C 21/3415; G01C 21/3667; G01C 21/3446; G01C 21/3476; G01C 21/3629

(57) ABSTRACT

A method is disclosed to enable travel routing devices and systems to accept and perform user instructions to add or remove intermediary travel stops along an existing travel route on-demand without having to cancel the existing route. The new method is termed as the OTW method or the OnTheWay method for a travel routing system. The OTW method includes steps to dynamically add or remove OTW stops along a travel route, a concept of an intermediary location for OTW stop lookup and the mechanism for its specification, an algorithm and a method to rank and to display OTW stop options, and suggested methods for device displays and user inputs to select and route with OTW stops.

### CROSS-REFERENCES TO RELATED APPLICATIONS

NA

### (g) BACKGROUND OF THE INVENTION

### (1) Field of the Invention

The methods and techniques described below relate generally to the field of GPS and other location based travel routing systems, and, more specifically to enhance today's travel routing capability to include an on-demand on-the-way (OTW) stop along an existing travel route.

The classification of the present invention include: U.S. Classification: 701/410, 701/425, 701/431, 701/465, 701/466, 701/467, 701/468, 340/988.

### (h) BRIEF SUMMARY OF THE INVENTION

Today, GPS location based navigation devices and systems provide convenience for user to find optimal driving directions from location A (often the current GPS location) to a location B (the location for a travel destination). These devices and systems are prevalent in vehicle navigation systems, smart phone map apps, and GPS navigation devices.

As advanced as these devices are, it is still very cumbersome to identify interested stop routes along an existing travel route without losing the current routing directions. For example, on my way from Philadelphia to Washington DC, if I would like find a lunch stop around Baltimore, I would need to first cancel my current travel route before I can create a new route to a lunch location in Baltimore. After my lunch stop, I will need to re-enter my original DC destination manually to resume my travel route to DC. This has multiple disadvantages:
The method is cumbersome that requires me to cancel my existing route manually; manually enter a new stop destination without knowing how much time or distance it will cost me to reach my original destination; and finally manually re-enter the original destination after the stop.
There are no convenient ways to explore better stops with minimum delays.
Although methods for identifying point of interest along an existing route exist, they are not optimized and utilized for identifying on-demand OTW (on the way or OnTheWay) stops often needed for common travels.

The present invention fills the needs to provide a convenient mechanism for users to add or remove OTW stops to an existing travel route with an enhanced travel routing device, or an ERD. An ERD device a location-based travel routing device that incorporates the method described here.

### (i) BRIEF DESCRIPTION OF THE FIGURES

FIG. 1: A depiction of a typical existing travel direction navigation routing system.

FIG. 2: A block diagram describing the method and steps for adding an OTW stop to an existing route.

FIG. 3: Steps and diagrams for identifying an intermediary OTW point from an existing travel route.

FIG. 4: Steps and diagrams for identifying and routing to an OTW stop.

FIG. 5: Steps and diagrams for adding multiple OTW stops

FIG. 6: Steps and diagrams for removing one or all OTW stops on a travel route.

FIG. 7: Depiction of a sample algorithm that calculates the costs of adding an OTW stop to a travel route by time and/or distance and to calculate the ranks of OTW stop options.

### (j) DETAILED DESCRIPTION OF THE INVENTION

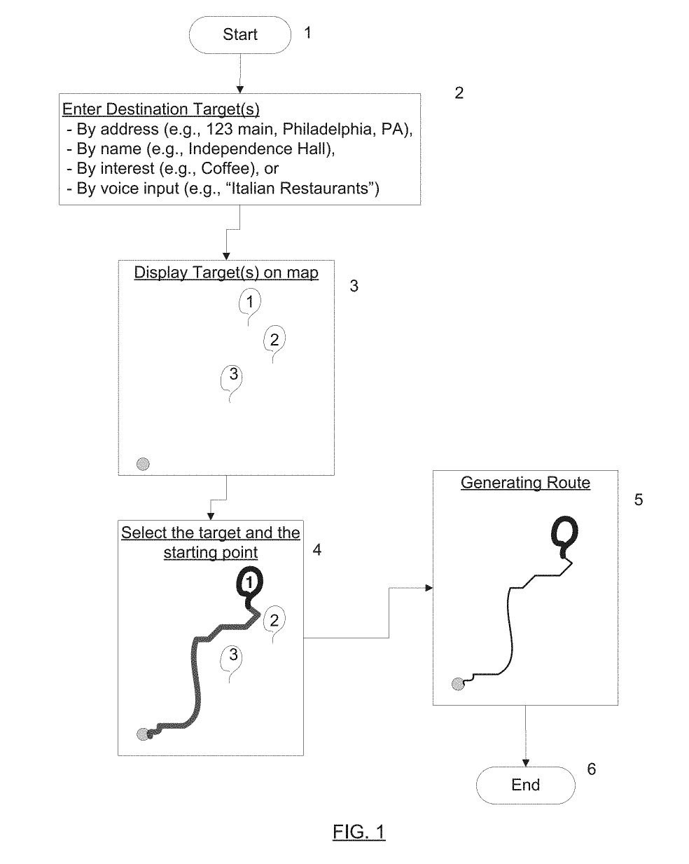

FIG. 1 outlines the following relevant aspects of the today's travel and GPS direction routing capabilities:
1. A target destination can be identified as any of the following: the actual street address; name of a landmark; the name or description of an interest such as coffee, restaurant, park, etc.; or by voice commands if supported by the travel routing device.
2. If identification of a destination is not unique, a list of close matches are ranked and displayed on the device either as selectable map positions or selectable items on a list, see FIG. 1 (3).
3. The ranking can be based on user-defined “mode” such as shortest time of travel, shortest distance of travel from the current position. Other modes such as traffic, weather, toll cost can be configured depending on the devices capability. If the starting point of the route is not identified, the ranking is usually based on the shortest distance to the center of the map or the current GPS location on the map.
4. The mode setting can be configured by a user or by the device default.
5. Once the destination targets are presented, an user can explore the targets by highlighting a target through touch screen or scroll to a target through a device provided keypad. Depending on the device capability, a preview of the routes to the selected target and the corresponding distance and/or time to the destination from the current position or a user selected starting location may be presented to the user, see FIG. 1 (4).
6. Once a user selects a target destination, the device presents the travel route to the target destination either from the current GPS location or a user selected starting location, see FIG. 1 (5). Depending on a device capability, a series of routing and travel data can be presented to the user. This typically includes both distance and time to the destination; next turn information; and other data such as traffic, etc.

Depending on the routing device, some or all of the above features can be provided. Examples of today's travel routing devices include smart phone maps, specialized GPS routing devices, web page mapping applications, in vehicle GPS devices, etc.

Relating to the present invention, some or all of the aforementioned features and capabilities of today's travel routing devices are assumed, leveraged, and incorporated as the basis for the present invention.

As outlined, today's travel routing systems have many features for identifying and generating travel routes from point A to point B. This is perfectly fine if a user doesn't have any on-demand changes during travel from the pre-planned travel route. As it often happens, especially during long road trips, a user often has the needs to add a stop or two along a travel route. This is where today's travel routing devices break down. A user either has to explore the desired stops without the routing assistance or a user is likely to go through the following:
1. Manually cancel the current route; then,
2. Manually find a desired stop as the new destination; then,
3. Manually route the device to the new stop location as an intermediary destination; then,
4. After the stop, manually reroute back to the original destination.

The essence of the present invention is a method to improve the travel routing device capabilities by allowing a user to add a desired stop to an existing travel route on-demand without having to cancel the current route while utilizing all existing system routing capabilities including but not limited to the capabilities of finding a point of interest on a map, routing from location A to location B, configuring to optimize against user specified preference such as travel time, travel distance, travel toll, and other multi-modal capabilities described in FIG. 1. A travel routing device enhanced with the described capabilities is called an enhanced routing device or an ERD.

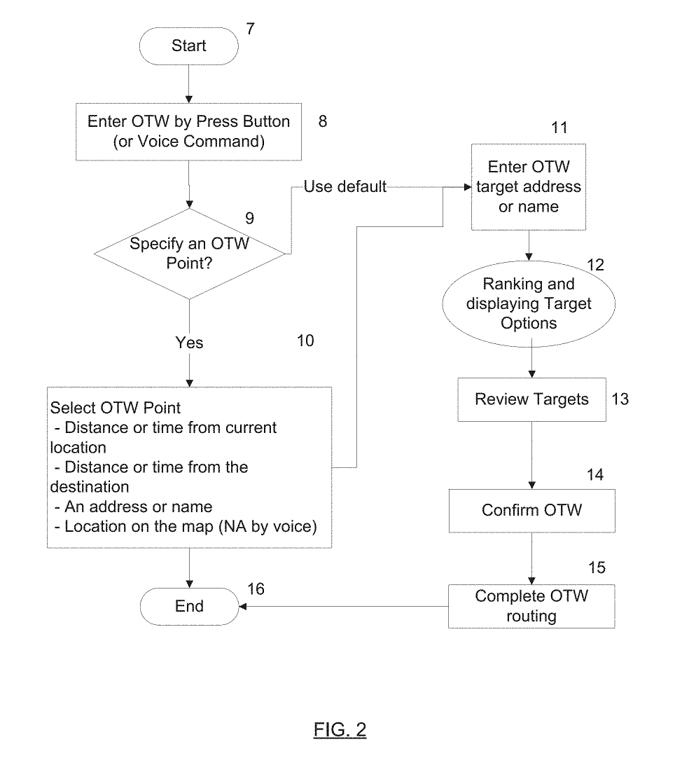

FIG. 2 outlines the main steps of the present invention. Given an existing travel route as described in FIG. 1, for a user to conveniently add an intermediary stop along the route, or an OTW (on the way or OnTheWay) stop, a concept of OTW point is introduced. An OTW point is the geographical location against which OTW stop options are searched and ranked.

When finding an OTW stop along an existing travel route, a user can elect to explicitly define an OTW point or use the default OTW point by the system, see FIG. 2 (9). A default OTW point is the current GPS location on a travel route or the starting location of the route if GPS-based navigation has not yet started.

The present invention provides a few ways to easily identify an OTW point, see FIG. 2 (10). A user can define an OTW point by specifying the distance or travel time from the current location. For examples, a user can define an OTW point by specifying it as the location 10 miles from the current location along the travel route. Or a user can define an OTW point as the location 15 minutes from the current location along the current route.

Because the capability of estimating distance and time duration along a route already exists in today's travel routing systems, the above instructions can be easily implemented, although implementation of features described by the present invention to an ERD is not within the scope of the present invention;

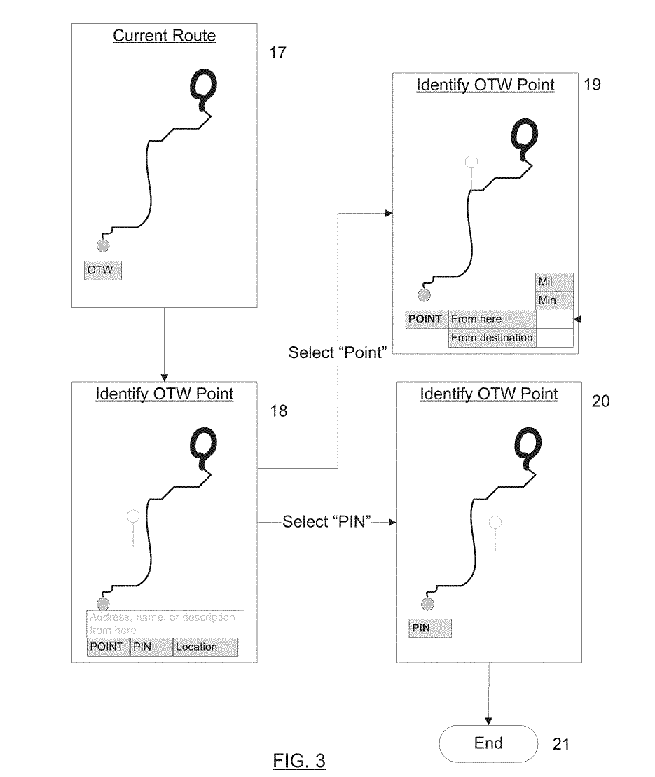

Similarly a user can define an OTW point by specifying the distance or travel time to the destination on the current route. See FIG. 3 (19); Or, a user can identify an OTW point by entering an address, a landmark, a name, or a phrase, just like what one would do to find a location on a regular device, see FIG. 3 (18). This sometimes can result in multiple results. For examples, if a name such as “Baltimore” is entered as the search input for an OTW point, it is possible that an ERD could return multiple matching locations. In those cases, a user would select a desired OTW point either by a touch screen selection or by scrolling through a list of options depending on the device capabilities; Or a user could specify an OTW point by selecting a point on the current travel map if the capability is available on the device, see FIG. 3 (20).

If an explicit OTW is not specified, then the default OTW point is assumed. The default OTW point is the current GPS location or the starting point of the current route if GPS based navigation has not yet started.

An explicit OTW point should be displayed by a visual mark on an ERD device. For example, a visual symbol such as a map drop pin should be sufficient, see FIG. 3. An drop pin based visual mark is also convenient to allow a user to then “refine” the location by manually move the pin on the map if the capability on a touchscreen ERD is supported. No visual marks are necessary for the OTW point.

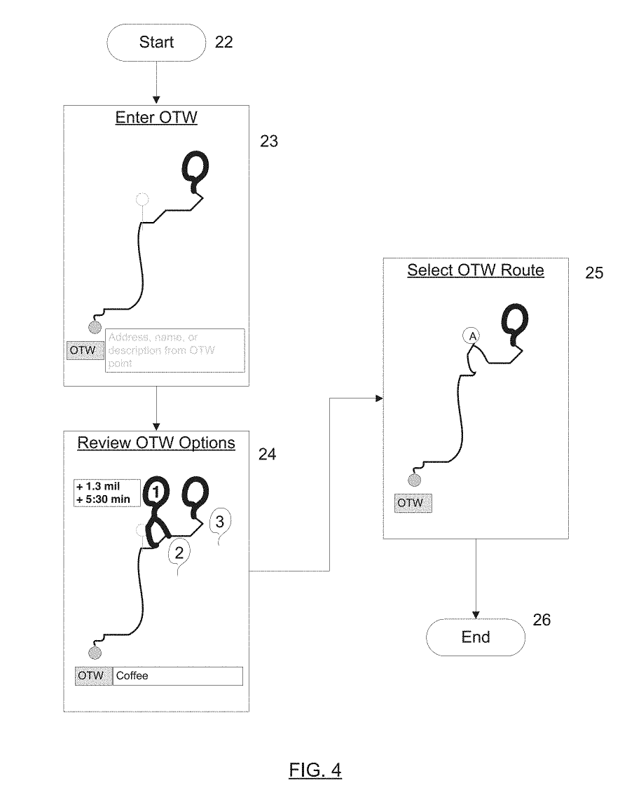

Once an OTW point is selected, by default or explicitly, a user can then enter a target OTW stops using today's travel routing device capabilities, either by entering an address, a name, or a phrase of interest, see FIG. 2 (12) and FIG. 4 (23). An ERD will then provide search results by ranking its matching database locations based on a pre-configured ERD search criteria with the OTW point as the reference location for the search, see FIG. 2 (12), FIG. 4 (24). The device configuration on search criteria can be multi-modal. The ranking of the search results is based on the current search mode on the device that is the same as what the device had used to generate the existing travel route. For examples, if the current route is determined based on the fastest time to destination—search mode is by time, then the ranking for OTW stop options will be based on the least amount of time added to the existing route; if the current route is determined based on the shortest distance to the destination—search mode is by distance, then the ranking will be based on the shortest distance added to the existing route.

The ranking results of OTW stops can be displayed in sequential numbers or other obvious visual marks that uniquely label each OTW stop option in sequence. The added time and distance estimates for an OTW route compared to that of the current route could be displayed next to a graphical display of an OTW stop option, see FIG. 4 (24). A user can explore the OTW stops by highlighting a stop to preview the routes to the stop and to see the time and distance that would be added to the existing route, see FIG. 4 (24).

Once an OTW stop option is selected, an ERD device generates the new route that includes the selected OTW stop as the intermediary destination. The OTW stop becomes the next travel destination with the original destination unchanged as the final destination, see FIG. 4 (25). An OTW stop is given a unique label, such as “A”.

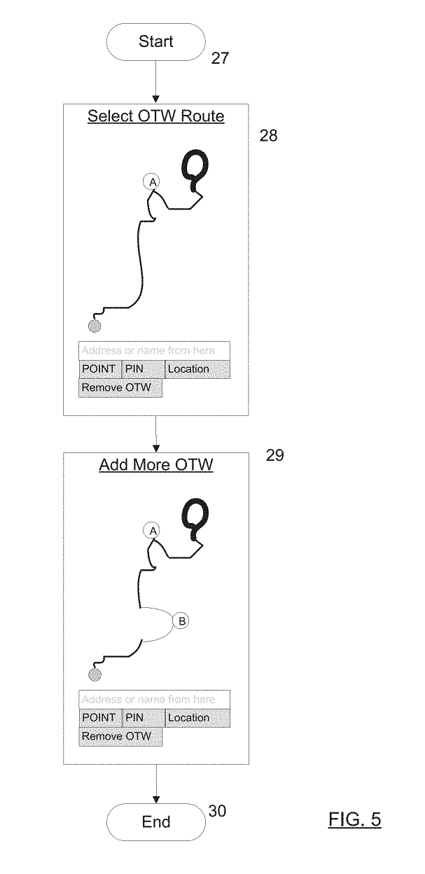

With the same steps and method, additional OTW stops can be added to the route with new labels such as “B”, etc., see FIG. 5 (29).

Today's GPS based travel routing systems have the capability to reroute to a destination when a user (or traveler) has veered off course. A travel GPS device would typically reroute dynamically to the defined destination when certain off course criteria are met. With an OTW stop defined on a route, the same capability to dynamically reroute is expected. The difference is that an ERD system would reroute to the next OTW stop instead, while the rest of the travel stops and routes are not affected.

An OTW stop is automatically removed once the stop is reached, determined by an ERD.

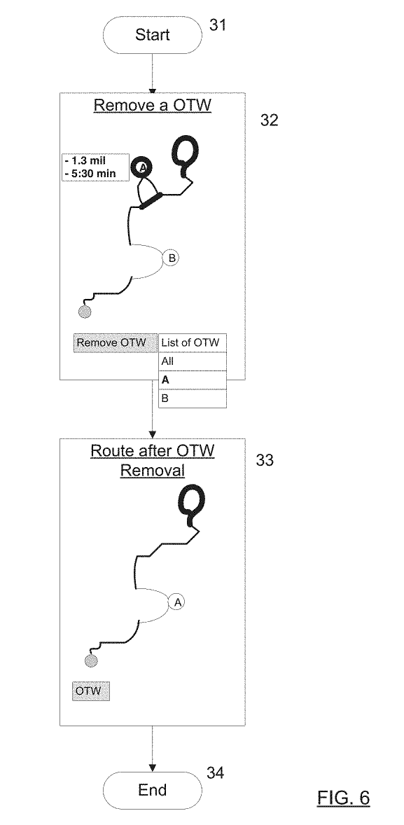

An OTW stop can also be removed manually by selecting an OTW Remove function that should be provided by an ERD device once OTW stops are added. Once the OTW Remove function is selected, and when an OTW stop is selected, an ERD device should show the delta distance and time reduced, plus a preview of the resulting route should the stop be removed, see FIG. 6 (32). When the OTW Remove function is selected, an ERD device should also provide the option of either removing a single OTW stop or all of the OTW stops, see FIG. 6 (32).

Once a user confirms to remove an OTW stop or all of the OTW stops, the resulting route is presented with the OTW stop removed, see FIG. 6 (33). Depending on the OTW stop labeling mechanism, an ERD may elect to re-label the remaining OTW stops to make them more user friendly.

If an ERD device has voice command capabilities like those on iOS or Android devices, a user could also enter OTW instructions via voice commands to add an OTW point, to find an OTW stop, or to remove an OTW stop. For example, to add an OTW stop, one could issue the following voice commands:
“Add an On the Way stop about 10 miles from here for coffee”

This phrase, when parsed, contains the following instructions: Add an OTW stop; use an intermediary OTW point 10 miles from the current GPS location; find a coffee location around the OTW point ranked based on the current route.

A voice-enabled command system such as Apple's Siri has many artificially intelligence capabilities to parse a variety of phrases for the same user intent. The same voice command can also be divided and sequenced to multiple voice commands. For example, the same voice command can be issued as a sequence of user-to-ERD “conversations” like below:
The user: “Add an OTW stop”
ERD device voice: “Do you want to add an On the Way point?”
The user: “yes”
ERD device voice: “Where would you like to add the On the Way point?”
The user: “10 miles from here”
ERD device voice: “Okay, where would you like to stop?”
The user: “Coffee”
ERD device voice: “Here is a list of coffee stops about 10 mile from here on your current route”

The method of inputting commands including voice commands to manage OTW stops is part of the present invention. However, the ability to receive voice commands by an ERD is a prior art capability of today's travel routing devices.

Other examples of voice commands include:
“Add an On the Way stop around City Hall, Philadelphia for Italian”, which instructs an ERD device to find an OTW stop for an Italian restaurant using City Hall, Philadelphia as the OTW point.
“Add a stop for gas”, which instructs an ERD device to find a gas station from the current location (using the defaulting OTW point which is the current location).

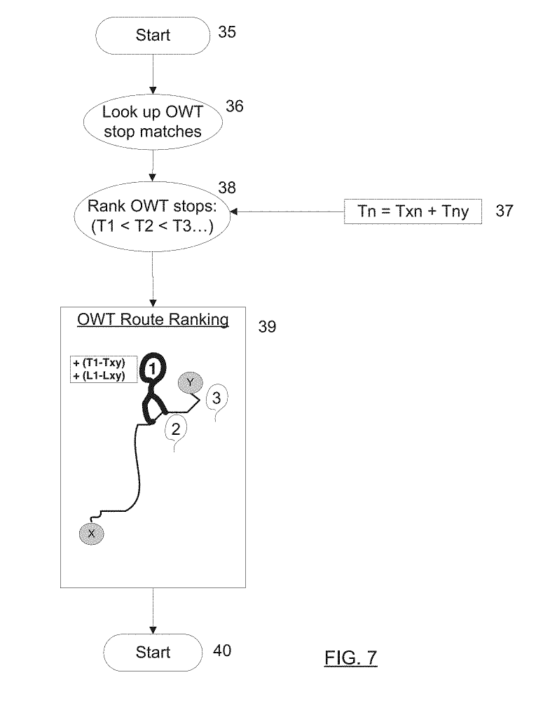

The present invention also includes a suggested algorithm for determining rankings of OTW stops as illustrated in FIG. 7. The algorithm leverages a routing system's capability to identify and calculate the best travel routes between location A and location B.

Before describing the algorithm, let's first define some concepts and symbols. As shown in FIG. 7, T stands for time interval of a route. T_{xy} stands for time interval for the travel route between location X and location Y. For an OTW stop such as “stop 1”, T₁ stands for Tₓ₁+T_{1y} where X indicates the starting location of the current route and Y indicates the destination of the current route, see FIG. 7 (37). L stands for the travel distance of a route. The same sub-labeling methods for T also apply to L.

The algorithm for finding OTW stop rankings in the present invention is described at a high-level in the following steps and is illustrated by FIG. 7:
1. Utilizing existing device database and location matching capability to identify possible target locations, see FIG. 7 (36)
2. Instead of ranking the matching locations by the travel duration (or by other factors like distance, toll, etc.) from the starting point, the ranking logic is based on the combined time durations of two intervals, one from the starting location to a candidate OTW stop (Tₓ₁), the other from the same candidate OTW stop to the current route destination (T_{1y}). So T₁=Tₓ₁+T_{1y}, T₂=Tₓ₂+T_{2y}, T₃=Tₓ₃+T_{3y}, for candidate OTW stops of “1”, “2,” and “3” respectively, see FIG. 7 (37). The rankings for an OTW stop is then based on the least time calculation for Tₙ where T₁<T₂<T₃, FIG. 7 (38).
3. The recommended data display for a selected OTW stop “1” is the delta time and distance between the total routing time T₁ and total routing distance L₁ to the original route intervals T_{xy} and L_{xy}, which are: time difference=T₁-T_{xy} and distance difference=L₁-L_{xy}, see FIG. 7 (39).

The algorithm described above would require roughly twice the processing time as the algorithm for generating routes between location A and location B because for each OTW stop candidate, two route durations must be computed rather than one. This is still a very efficient algorithm. It is possible that more efficient algorithms exist based on the same spirit of the algorithm described here.

The forgoing description of the invention is presented for the purposes of illustration and description. It is not intended to be exhaustive or limited to the invention to the precise form disclosed. Variations and modifications are obvious and possible in the context of this disclosure. It is intended that the invention be not limited by the forgoing descriptions, but rather by the spirit of the description and claims appended hereto.

What is claimed is:

1. A travel routing method that identifies, ranks, adds, or removes intermediary stops along an existing travel route without having to first cancel the route, called the OTW (on the way) method, the method comprising the steps of:
identifying an intermediary OTW point;
finding and ranking interested stop options around the intermediary OTW point based on added time or distance to an existing route;
previewing the new routes for an OTW stop;
re-routing to include an selected OTW stop;
repeating the steps for adding multiple OTW stops; and
removing one or all of existing OTW stops.

2. The travel routing method of claim 1 further comprising a concept and a method to identify an intermediary point along an existing travel route, called an OTW point.

3. The travel routing method of claim 2, wherein can be defined on an route by either distance or time relative to either the starting location or the destination of the route.

4. The travel routing method of claim 2, wherein can be defined as an absolute address, a location on a map, a landmark by name, or any close match to a description or phrase.

4. The travel routing method of claim 2, wherein can be defined by a voice command available to an ERD device.

6. The travel routing method of claim 2, wherein suggests a visual display to show a defined OTW point on the map of an ERD device.

7. The travel routing method of claim 1 further comprising a method for finding and selecting an OTW stop relative to an OTW point.

8. The travel routing method of claim 7 further comprising a method and a graphical depiction of a user input to look up an OTW stop.

9. The travel routing method of claim 7 further comprising a method for a user to provide voice command to an ERD device to look up an OTW stop.

10. The travel routing method of claim 7 further comprising a method and a graphical depiction that shows a list of ranked matching OTW stop options.

11. The travel routing method of claim 10, wherein includes an algorithm to calculate the delta time and distance of a new route compared to those of the current route.

12. The travel routing method of claim 10, wherein includes an algorithm to rank a list of matching OTW stops based on the delta distances and times of the corresponding OTW routes to the original route.

13. The travel routing method of claim 7 further comprising a method for selecting an OTW stop from the list of OTW stop options and previewing the would-be route for the OTW stop.

14. The travel routing method of claim 7 further comprising a method to update the travel route based on a selected OTW stop. The new route becomes the active route.

15. The travel routing method of claim 14, wherein includes a method to uniquely label an OTW stop on the new route.

16. The travel routing method of claim 1 further comprising a method to repeat the entire method to recursively add an additional OTW stop to a route already containing other OTW stops.

17. The travel routing method of claim 1 further comprising a method to identify and remove one or all of the OTW stops from a travel route.

18. The travel routing method of claim 17 further comprising a method for displaying and previewing the effect of removing a selected OTW stop by showing the delta time and distance gained, plus a graphical display of the would-be new route after a selected OTW stop is removed.

19. The travel routing method of claim 17 further comprising a method for generating and displaying the resulting route after the specified OTW stops are removed.

20. The travel routing method of claim 17 further comprising a method to remove one or all of the OTW stops by voice commands.
